(19) United States
(12) Patent Application Publication
(10) Pub. No.: US 2026/0354953 A1
(43) Pub. Date: Nov. 12, 2026

(54) Actuated Flossing Tool

(71) Applicants: Leonhardt Andersen, Erie, PA (US); William Morosky, Erie, PA (US)

(72) Inventors: Leonhardt Andersen, Erie, PA (US); William Morosky, Erie, PA (US)

(21) Appl. No.: 19/130,727

(22) PCT Filed: Nov. 17, 2023
(86) PCT No.: PCT/US2023/080413

§ 371 Date: May 16, 2025

Related U.S. Application Data
(60) Provisional application No. 63/426,047, filed on Nov. 17, 2022.
(60) Provisional application No. 63/448,250, filed on Feb. 25, 2023.
(60) Provisional application No. 63/455,561, filed on Mar. 30, 2023.

(51) Int. Cl. A61C 15/04

(52) U.S. Cl. CPC A61C 15/047; A61C 15/048; A61C 2204/002

(57) ABSTRACT

An actuated flossing tool includes a tool body having a major tool axis, a first distal end, and a headstock at the first distal end. An initial string positioner and a rotatable string positioner, each having a first positioner arm and a second positioner arm, are both positioned on the tool at the headstock. A floss string extends from the first positioner arm to the second positioner arm on both the initial and rotatable string positioners. The floss strings of the rotatable and initial string positioners cross relative the headstock. The rotatable string positioner is positioned to rotate from a first string position to a second string position relative the headstock. An angle adjuster is positioned to allow adjustment of the rotatable string positioner from the first string position to the second string position. A vibrator is positioned to vibrate said floss strings during use.

### BACKGROUND OF THE INVENTION

Dental floss is used to remove food particles and plaque from between teeth and gums. While flossing using a single floss string, a user typically pinches or winds each end of a length of the floss string, which is normally disposable, between the fingers of one hand to suspend the floss string and then maneuver the string between and around teeth and gums. This typically requires the fingers to enter the user's mouth, making the flossing procedure unhygienic and difficult for the user to effectively maneuver the floss string and reach hard-to-reach spots.

To address these problems, flossing tools have been introduced, which are also commonly disposable. Such flossing tools often utilize a handle or other tool body connected to two string positioners, with each string positioner connected to one end of a length of floss string and suspending the length of string firmly therebetween. The flossing operation can then often be accomplished using a single hand, without requiring the user's hands to enter the mouth, and allowing the user to position the floss string to optimal string orientations to significantly improve food and plaque removal. However, prior flossing tools have been limited in their utility in that they do not allow for the simultaneous accommodation multiple or variable flossing angles. In addition, the cleaning effectiveness of such prior flossing tools is limited to the user's success in positioning and manipulating the tool while flossing.

### SUMMARY OF THE INVENTION

An actuated flossing tool includes a tool body having a major tool axis, a first distal end, and a headstock at the first distal end. An initial string positioner and a rotatable string positioner, each having a first positioner arm and a second positioner arm, are both positioned on the tool at the headstock. A length of floss string extends from the first positioner arm to the second positioner arm on both the initial and rotatable string positioners. Both the initial and rotatable string positioners may be removable and disposable. The floss string of the rotatable string positioner crosses the floss string of the initial string positioner relative the headstock.

The rotatable string positioner is positioned to rotate on a positioner pivot from a first string position to a second string position relative the headstock. An angle adjuster is positioned to allow adjustment of the rotatable string positioner from the first string position to the second string position.

A vibrator is positioned to vibrate said floss strings during use. The vibrator may be operated with a power switch positioned on the tool body. The power switch may be variable to allow a user to operate the vibrator to vibrate the floss strings at selectable vibration speeds during use. Vibration can be rotational or oscillating to create multidirectional agitation during flossing.

Among the numerous advantages of the current invention is the maximization of flossing effectiveness by allowing a user to focus on optimizing the position of the flossing tool without the need for the user to create stroking or reciprocating flossing motions, as the vibrations of the flossing tool automatically effect flossing action when in position. Crossed variable positioning of the floss strings also allows the flossing tool to wrap further around and remain in contact with a larger percentage of the circumference of a tooth more effectively while also improving the crossing of proximal surfaces of adjacent teeth. The crossed, vibrating strings allow the flossing tool to reach beyond the proximal surface to more effectively cover both cheek side and tongue side of teeth, with a resulting c-shape of floss strings making superior contact with the circumference of each tooth. The tool also reduces need for a user to actively find hard to reach spots and eliminates the need for the user to unhygienically insert fingers inside the mouth for floss positioning. As the tool allows for far superior maneuvering around the mouth, it also allows for better floss action under the gum line.

### BRIEF DESCRIPTION OF THE DRAWINGS

For a more complete understanding and appreciation of this invention, and its many advantages, reference will be made to the following Detailed Description of the Invention taken in conjunction with the accompanying drawings.

FIG. 1 is a front perspective view of an actuated flossing tool according to one contemplated embodiment of the invention;

FIG. 2 is a top magnified view of the actuated flossing tool of FIG. 1;

FIG. 3 is a front perspective exploded view of the actuated flossing tool of FIG. 1;

FIG. 4 is a cross sectional perspective view of the actuated flossing tool of FIG. 1;

FIG. 5 is a broken top view of the angle adjustment mechanism of the actuated flossing tool of FIG. 1;

FIG. 6 is a top magnified view of the actuated flossing tool of FIG. 1;

FIG. 7 is cross sectional perspective view of the actuated flossing tool of FIG. 1;

FIG. 8 is a broken top view of the angle adjustment mechanism of the actuated flossing tool of FIG. 1;

FIG. 9 is a front perspective view of the actuated flossing tool of FIG. 1;

FIG. 10 is a front perspective view of the actuated flossing tool of FIG. 1;

FIG. 11 is a table of example clickable button switch settings;

FIG. 12 is a table of example rotational cam vibrator settings and speeds;

FIG. 13 is a table of example sonic oscillator vibrator settings and frequencies;

FIG. 14 is a perspective view of an actuated flossing tool according to one contemplated embodiment of the invention;

FIG. 15 is a perspective view of an actuated flossing tool according to one contemplated embodiment of the invention;

FIG. 16 is a cross sectional perspective view of an actuated flossing tool according to one contemplated embodiment of the invention;

FIG. 17 is a magnified cross sectional view of the actuated flossing tool of FIG. 16;

FIG. 18A is a top view of the actuated flossing tool of FIG. 16;

FIG. 18B is a top view of the actuated flossing tool of FIG. 16;

FIG. 18C is a top view of the actuated flossing tool of FIG. 16;

FIG. 19A is a top view of an actuated flossing tool according to one contemplated embodiment of the invention;

FIG. 19B is a top view of the actuated flossing tool of FIG. 19A;

FIG. 19C is a top view of the actuated flossing tool of FIG. 19A;

FIG. 20 is a perspective view of an actuated flossing tool according to one contemplated embodiment of the invention;

FIG. 21 is a perspective view of an actuated flossing tool according to one contemplated embodiment of the invention;

FIG. 22 is a magnified top view of the actuated flossing tool of FIG. 21;

FIG. 23 is a perspective view of an actuated flossing tool according to one contemplated embodiment of the invention;

FIG. 24 is a magnified top view of the actuated flossing tool of FIG. 23;

FIG. 25 is a magnified cross sectional perspective view of the actuated flossing tool of FIG. 23;

FIG. 26 is a perspective view of an actuated flossing tool according to one contemplated embodiment of the invention;

FIG. 27A is a magnified top view of an actuated flossing tool according to one contemplated embodiment of the invention;

FIG. 27B is a magnified top view of the actuated flossing tool of FIG. 27A;

FIG. 27C is a magnified top view of the actuated flossing tool of FIG. 27A;

FIG. 28 is a perspective view of an actuated flossing tool according to one contemplated embodiment of the invention;

FIG. 29 is a magnified top view of the actuated flossing tool of FIG. 28;

FIG. 30 is a cross sectional perspective view of the actuated flossing tool of FIG. 28;

FIG. 31 is a magnified top view of the actuated flossing tool of FIG. 28;

FIG. 32 is a perspective view of an actuated flossing tool according to one contemplated embodiment of the invention;

FIG. 33 is a magnified perspective view of the actuated flossing tool of FIG. 32;

FIG. 34 is a perspective view of an actuated flossing tool according to one contemplated embodiment of the invention;

FIG. 35 is a magnified top view of the actuated flossing tool of FIG. 34; and

FIG. 36 is a magnified top view of the actuated flossing tool of FIG. 34.

### DETAILED DESCRIPTION OF THE INVENTION

Referring to the drawings, some reference numerals are used to designate the same or corresponding parts through several of the embodiments and figures shown and described. Variations in corresponding parts are denoted in specific embodiments with the addition of lowercase letters. Subsequent variations in components that are depicted in the figures but not described are intended to correspond to the specific embodiments mentioned earlier and are discussed to the extent that they vary in form or function. It will be understood generally that variations in the embodiments could be interchanged without deviating from the intended scope of the invention.

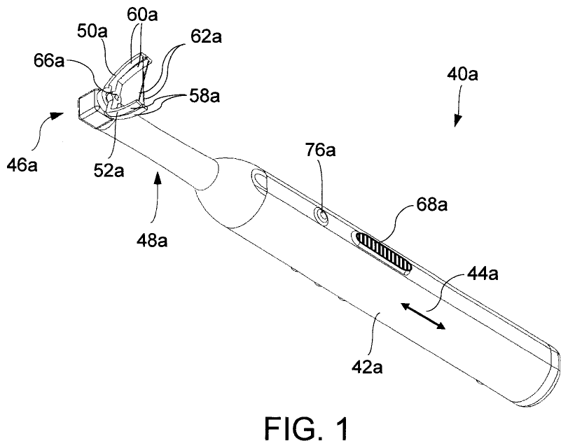

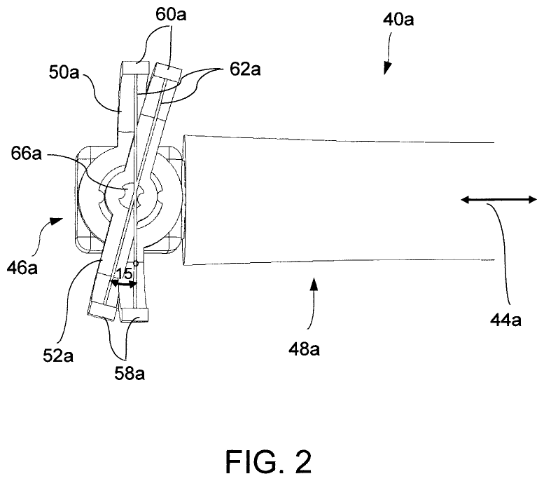

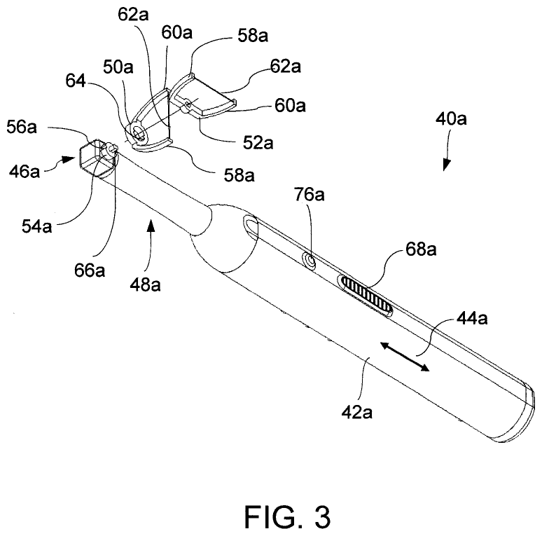

FIG. 1 depicts an actuated flossing tool 40a having a handle or tool body 42a defining a major tools axis 44a and a first distal end 46a. The tool 40a has a headstock 48a and a first distal end 46a. FIG. 2 depicts a close up top view of the first distal end 46a and headstock 48a of the flossing tool 40a of FIG. 1. As best understood by comparing FIGS. 1 and 2, an initial string positioner 50a and a rotatable string positioner 52a are located on the headstock 48a at the first distal end 46a. Comparing FIGS. 1 and 2 to the exploded view of the tool 40a in FIG. 3, each of initial and rotatable string positioners 50a and 52a include a first positioner arm 58a and second positioner arm 60a and a floss string 62a the floss string 62a extends from the first positioner arm 58a to the second positioner arm 60a. Male keying 64a is shaped into the initial string positioner 56a at the location of connection between the first positioner arm 58a and second positioner arm 60a to engage female keying 56a on a positioner mount 54a in fixed position on the headstock 48a. Once installed on the headstock 48a via the fixed positioner mount 54a, the engaged male keying 64a and female keying 56a prevent any movement of the initial string positioner 50a with respect to the headstock 48a or tool 40a. The rotatable string positioner 52a is mounted on the headstock 48a with a rotating positioner pivot 66a that extends from the headstock 48a through the positioner mount 54a.

As best understood with reference to FIG. 3, the male and female keying 64a and 56a allow for easy installation and removal of the initial and rotatable string positioners 50a and 52a and their floss strings 62a on the headstock 48a. This is advantageous as it allows for both the initial and rotatable string positioners 50a and 52a and their floss strings 62a to be disposable and refillable for both wear and hygiene.

When installed on the positioner mount 54a and positioner pivot 66a, the initial string positioner 50a and rotatable string positioner 52a are spring biased to a first string position that creates, as depicted in FIGS. 1 and 2, a 15 degree angle between the floss strings 62a. In this particular contemplated embodiment, this minimum 15 degree angle is limited by the rotational restriction created by contact between the first and second positioner arms 58a and 60a of both the initial and rotatable string positioners 50a and 52a.

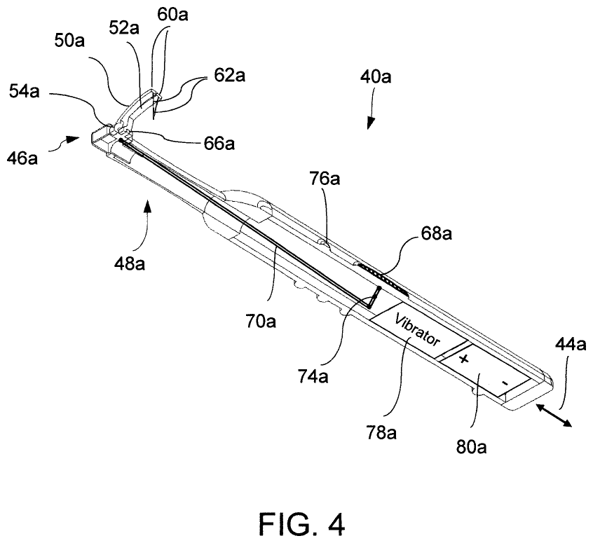

FIG. 4 depicts a front cross sectional view of the flossing tool 40a of FIG. 1 when the rotatable string positioner 52a is in the first string position creating a 15 degree angle between the floss string 62a as FIGS. 1 and 2. An angle adjustment mechanism 67a allows for user adjustment of the angle between cross strings 62a, moving the rotatable string positioner 52a to a second string position. As best understood by comparing FIGS. 1 and 4, the angle adjustment mechanism 67a includes a slidable angle adjuster 68a positioned to reciprocate along the handle or tool body 42a generally parallel to the major tool axis 44a.

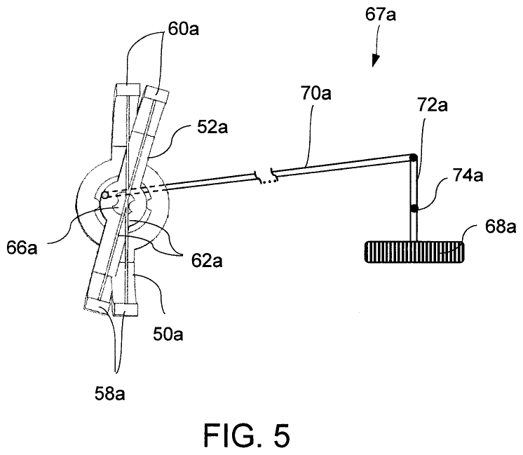

FIG. 5 depicts a broken top view of the components of the angle adjustment mechanism 67a of the flossing tool 40a of FIG. 1. The angle adjuster 68a is placed generally in a location allowing a user to manipulate and slide the adjuster 68a with the user's thumb when the user grasps the tool 40a with one hand. As depicted in FIGS. 4 and 5, the angle adjuster 68a is connected to one end of an adjuster shaft 70a with an adjuster link 72a. The adjuster link 72a is pivotally mounted on an adjuster pivot 74a that is fixed to the inside of the handle or tool body 42a. The adjuster shaft 70a extends along the major tool axis 44a of the flossing tool 40a to the headstock 48a where it connects to the positioner pivot 66a to which the rotatable string positioner 52a is mounted. The angle adjustment mechanism 67a is spring biased to place the rotatable string positioner 52a to the first string position, having a minimum angle of 15 degrees between the floss strings 62a, as depicted in FIGS. 1, 2, 4, and 5.

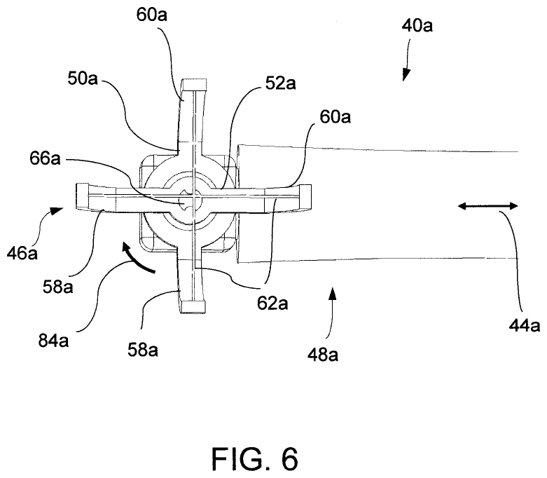

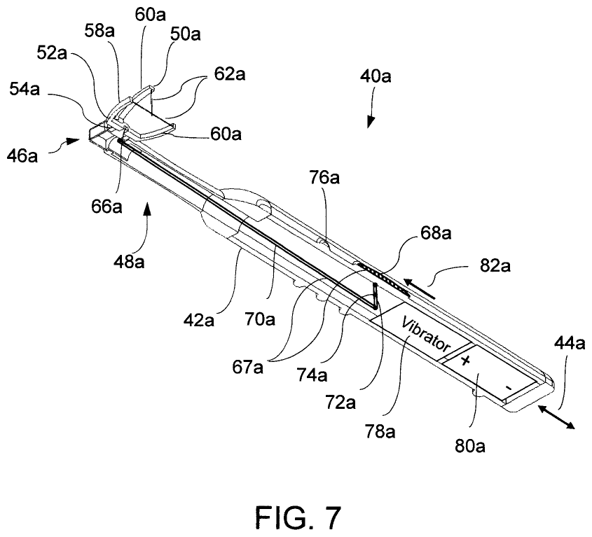

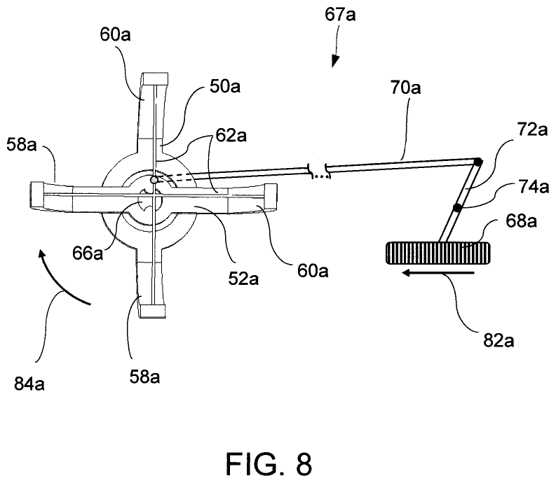

While flossing, a user holds the flossing tool 40a by the handle or tool body 42a with one hand, optimally with the user's thumb at or near the angle adjuster 68a. To increase the angle between the floss strings 62a, such as to the approximately 90 degree angle of the crossed floss strings 62a depicted in the top closeup view of the headstock 48a in FIG. 6, the user exerts forward sliding pressure against the angle adjuster 68a. As shown in the front cross sectional view of the flossing tool 40a in FIG. 7 and top view of the angle adjustment mechanism 67a in FIG. 8, this slides the angle adjuster 68a in the forward direction 82a, causing the connected adjuster link 72a to pivot about the adjuster pivot 74a and draw the adjuster shaft 70a away from the first distal end 46a of the tool 40a. This movement of the adjuster shaft 70a actuates the connected positioner pivot 66a to rotate the rotatable string positioner 52a in the clockwise direction 84a, moving the rotatable string positioner 52a to the second string position depicted in FIGS. 6-8.

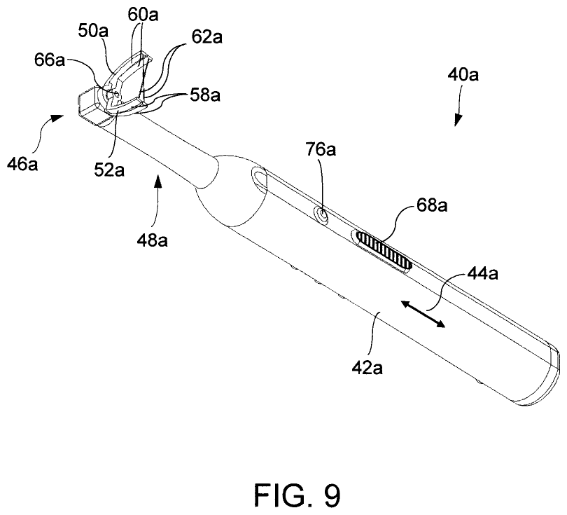

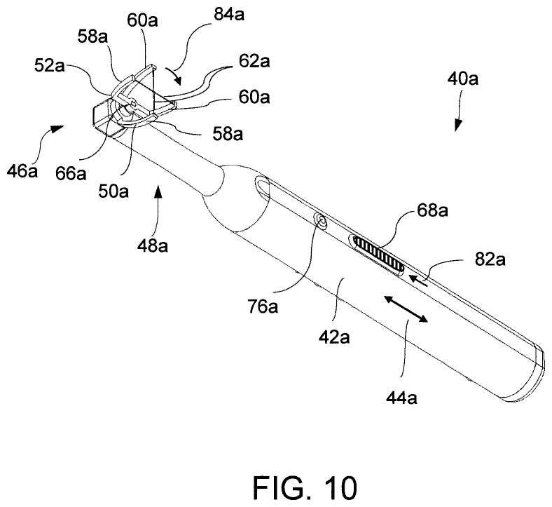

Since the angle adjustment mechanism 67a is spring biased to place the rotatable string positioner 52a, as depicted in FIGS. 1, 2, 4, and 5, to the first string position with a minimum angle of 15 degrees between the floss strings 62a, the mechanism 67a will shift back the position depicted in FIGS. 6-8 back to the position depicted in FIGS. 1, 2, 4, and 5 once the user releases pressure on the angle adjuster, returning the angle between the floss strings 62a back from 90 to 15 degrees. By continuing to exert and then release forward sliding pressure against the angle adjuster 68a in this way, the user can selectably vary the angle between the floss strings 62a to optimize crossed string positioning. This full range of motion by the rotatable string positioner 52a is best summarized in the comparison of the first string position—a crossed string angle of 15 degrees in FIG. 9, compared with a second string position—a crossed string angle of 90 degrees in FIG. 10.

Although the invention has been shown and described in the example depicted in FIGS. 1-10 as having a minimum angle of 15 degrees between floss strings, it will be appreciated the invention contemplates minimum angles as small as zero degrees through a full 90 degrees with crossed strings within the invention concept.

Referring again to FIGS. 1, 4, 7, and 8, the actuated flossing tool 40a provides vibrating action to the floss strings 62a with a vibrator 78a located within the handle or tool body 42a. Once the user has maneuvered the flossing tool 40a to the desired flossing position and has selected the desired angle between strings 62a, the user can then operate the vibrator 78a to enhance flossing effectiveness. While flossing and holding the flossing tool 40a by the handle or tool body 42a, the user's thumb is optimally positioned at or near a power switch 76a located on the exterior of the tool 40a. The power switch 76a depicted in FIGS. 1, 4, and 7 is easily depressed with the user's thumb while holding the tool 40a and simultaneously flossing, and the user's thumb can easily alternate between manipulation of the switch 76a and angle adjuster 68a.

The switch 76a allows the vibrator 78a to draw on an internal battery 80a which can itself be replaceable or rechargeable. Wireless recharging technology which is well known in the art is contemplated for use in some embodiments of the invention as such technology can allow the tool body 42a to remain sealed to more effectively prevent the intrusion of water into the tool 40a, protecting the electrical components within. The battery itself can be any suitable small appliance battery, such as the 49 mm×14 mm Li-ion Toothbrush & Shaver Battery—Pins available from Ionic Industries, Chichester, West Sussex, United Kingdom.

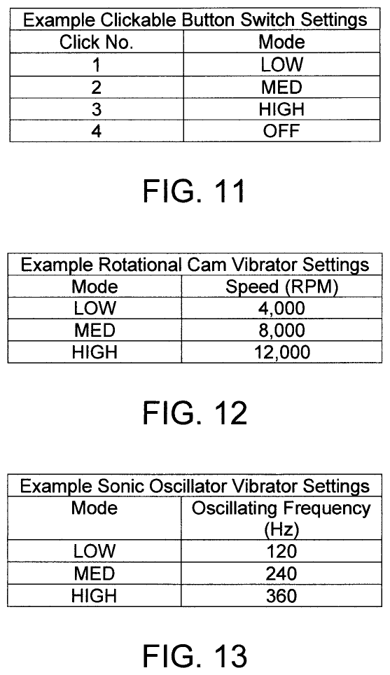

The switch 76a is typically liquid proof or sealed under a flexible waterproof material to prevent damage to the switch 76a from water, toothpaste, mouthwash, and bodily fluids present in the flossing environment. The switch 76a can be a conventional single or multiple speed plunger, lever, rocker or clickable ON/OFF switch. A simple ON/OFF switch would enable the user to operate the vibrator 78a at a single speed, while a multiple speed switch would enable the user to exercise variable speed control. Some contemplated embodiments would utilize a four-way clickable button switch having three operational speed modes of LOW, MED, and HIGH plus OFF, as represented by the table in FIG. 11.

The vibrator may comprise of any small appliance motor with cam, oscillator, self-contained vibrational device, or any other appropriately implemented vibrating mechanism.

For example, rotational motors, most often coupled with a cam or off-center weight distribution, can be used to produce rotational vibration. Such devices may operate at a single optimal rotational speed or allow for selectable variable speed. For example, some contemplated embodiments would utilize a four-way clickable button switch having three discreet operational speed modes of LOW, MED, and HIGH plus OFF, to control a rotational cam vibrating motor at possible discreet rotational speeds ranging from 4,000 to 12,000 RPM, as represented by the table in FIG. 12. An example of such an appropriately implemented motor would include the Vibration ERM MTR No. 108100006 (allowing 12,000 RPM at 3V), available from the Seeed Technology Co., Ltd. of Guangdong, Shenzhen City, China.

Vibrators utilizing oscillation/sonic oscillation can also be appropriately implemented within the contemplated scope of the invention. Such devices may also operate at a single optimal oscillating frequency or allow for selectable variable frequencies. For example, some contemplated embodiments would utilize a four-way clickable button switch having three discreet oscillating frequency modes of LOW, MED, and HIGH plus OFF, to control a sonic oscillating motor at possible discreet oscillating frequencies ranging from 120 to 360 Hz, as represented by the table in FIG. 13. An example of such an appropriately implemented oscillator would include the 16 mm Sonic Electric Toothbrush Motor Model NFP-161242-020-02 (allowing 360 Hz at 3.7V DC) available from the Need-For-Power (NFP) Motor Co. Ltd. of Tsim Sha Tsui, Hong Kong, China.

Although the invention has been shown and described using a conventional single or multiple speed plunger, lever, rocker or clickable ON/OFF switch for setting operational speeds at discreet selectable levels, it will be appreciated that switches utilizing analog control allowing for non-discreet selectable settings are also within the contemplated invention scope.

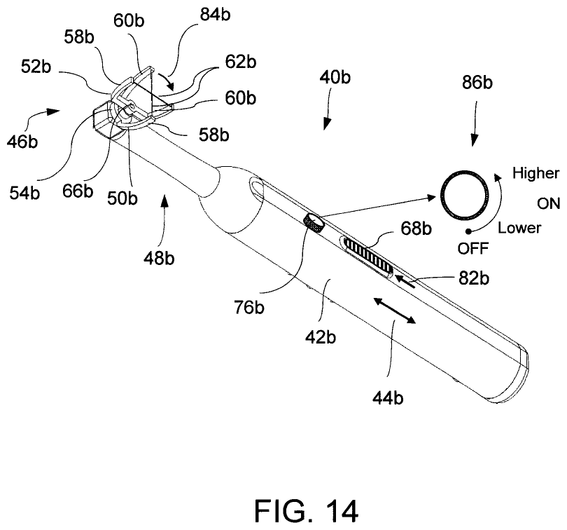

For example, FIG. 14 depicts an actuated flossing tool 40b of the invention during use in which a user has moved the angle adjuster 68b in the forward direction 82b, rotating the rotatable string positioner 52b in the clockwise direction 84b about the positioner pivot 66b to a second positioner position and creating an angle of approximately 90 degrees between the floss strings 62b. The tool 40b includes a power switch 76b that is an analog dial control, having a clicking OFF setting.

As best understood with reference to the settings diagram 86b in FIG. 14, when the user initially begins to rotate the power switch 76b in the counterclockwise direction, the power switch 76b will switch from the OFF position to a lower ON position having a lower vibrator speed corresponding to the exact rotated position of the power switch 76b. The vibrator will continue to increase to a higher speed as the user continues to rotate the power switch 76b in the counterclockwise direction until the vibrator (not shown in FIG. 14) meets its maximum speed or the user stops rotation, the exact final vibrator speed depending on the exact rotated position of the power switch 76b. In this way, assuming the tool 40b uses a rotational cam vibrator as in the table of FIG. 12, the vibrator can potentially achieve any speed within a range up to its maximum rotational speed (0-12,000 RPM) without being restricted to only three discreet speed levels. Assuming the tool 40b uses an oscillating vibrator as in the table of FIG. 13, the oscillating vibrator can potentially achieve any frequency within a range up to its maximum oscillating frequency (0-1360 Hz) without being restricted to only three discreet oscillating frequencies.

Although the invention has been shown and described as having a power switch that is an analog dial control allowing for any rotational vibrating speed or oscillating frequency within an operational range, it will be appreciated such switches that are dial controls can also include discreet settings.

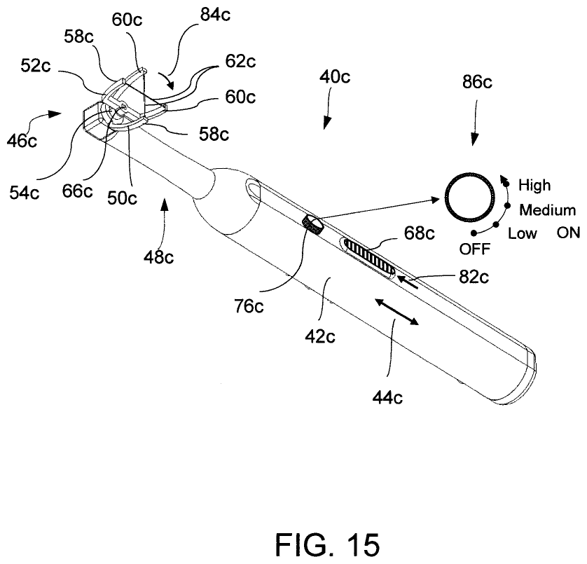

For example, FIG. 15 depicts an actuated flossing tool 40c of the invention during use in which a user has moved the angle adjuster 68c in the forward direction 82c, rotating the rotatable string positioner 52c in the clockwise direction 84c about the positioner pivot 66c to a second positioner position and creating an angle of approximately 90 degrees between the floss strings 62c. The tool 40c includes a power switch 76c that is a dial control having discreet High, Medium, Low, and OFF settings.

As best understood with reference to the settings diagram 86c in FIG. 15, when the user rotates the power switch 76c in the counterclockwise direction from the OFF position, the rotating power switch 76c will click to one of three discreet ON positions each corresponding to one selectable discreet setting. Assuming the tool 40c uses a rotational cam vibrator as in the table of FIG. 12, the vibrator (not shown in FIG. 15) is limited to one of the three discreet speed levels (4,000, 8,000, or 12,000 RPM). Assuming the tool 40c uses an oscillating vibrator as in the table of FIG. 13, the vibrator is limited to one of the three discreet oscillating frequencies (120, 240, or 360 Hz).

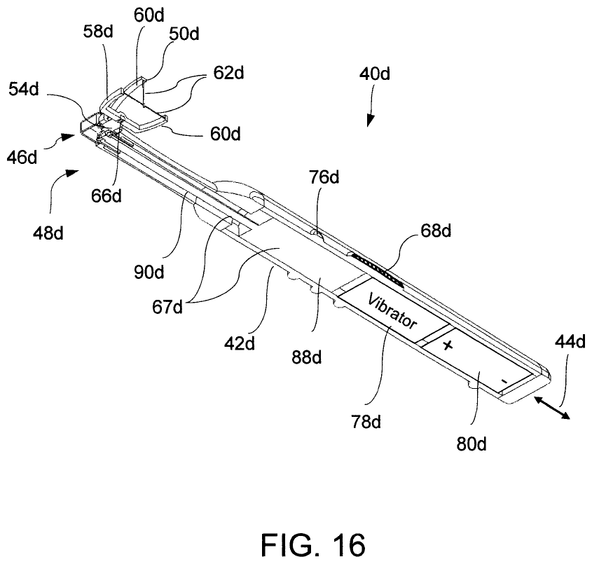

Although the invention has been shown and described as having a user-actuated angle adjustment mechanism utilizing a spring biased angle adjuster to reciprocate an adjuster shaft to cause the rotation a rotatable string positioner, it will be appreciated that other types of actuated adjustment mechanisms are also within the contemplated scope of the invention. For example, FIG. 16 is a perspective cross sectional view of an actuated flossing tool 40d of the invention having an angle adjustment mechanism 67d comprising a positioner motor 88d connected to a rotatable shaft 90d. The shaft 90d extends from the positioner motor 88d toward the first distal end 46d of the tool 40d and into the headstock 48d.

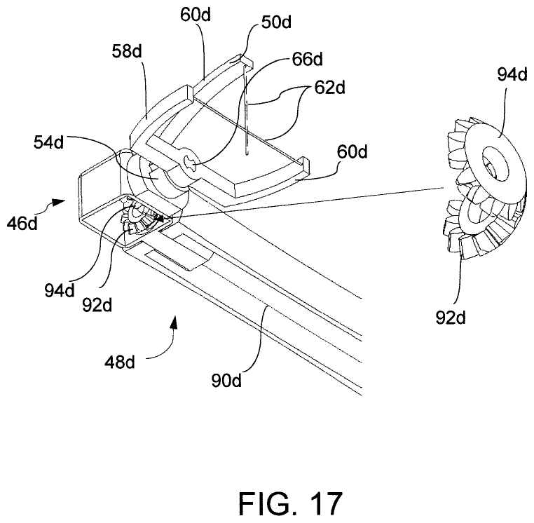

As best understood by comparing FIG. 16 with the magnified cross sectional perspective view of the headstock 48d in FIG. 17, a beveled shaft gear 92d is positioned at the end of the shaft 90d, the shaft gear 92d being positioned to drive a beveled positioner gear 94d coupled to the bottom of the positioner pivot 66d.

The angle adjustment mechanism 67d allows for adjustment between floss strings 62d by allowing for single-handed control of the positioner motor 88d, which, like the vibrator 78d, also draws on the battery 80d during use. The positioner motor 88d can be any appropriately implemented small appliance motor allowing for bidirectional shaft rotation or single direction shaft rotation when used with gearing for selective reverse. One example of an appropriately implemented positioner motor is the 6 mm Mini DC Gear Motor-20 mm Type Model NFP-609-699-0675 Standard Shaft available from the Need-For-Power (NFP) Motor Co. Ltd. of Tsim Sha Tsui, Hong Kong, China. However, it will be appreciated that numerous other types of small appliance motors can be utilized within the contemplated scope of the invention. The angle adjustment mechanism 67d also includes an angle adjuster 68d that is slidable along the handle or tool body 42d generally parallel to the major tool axis 44d of the tool 40d and easily manipulated with a user's thumb when the tool 40d is held with one hand. The angle adjuster 68d functions as a switch to activate the positioner motor 88d and adjust the angle between the floss strings 62d.

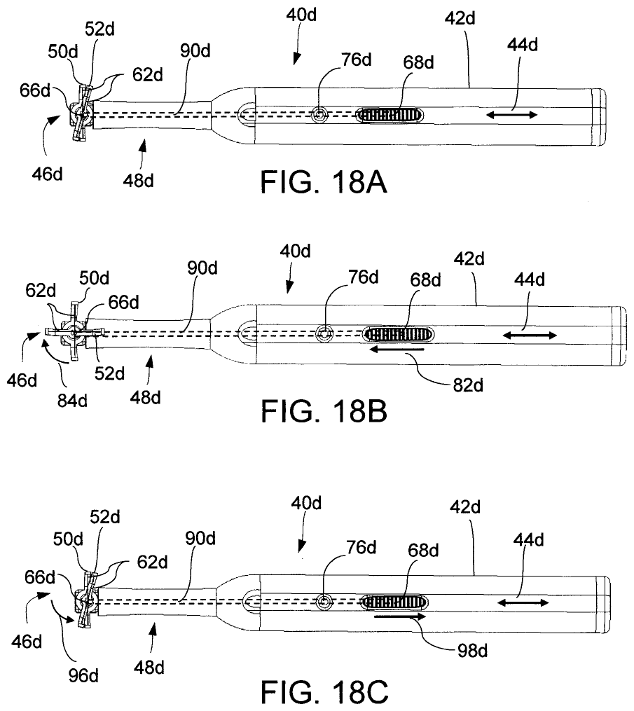

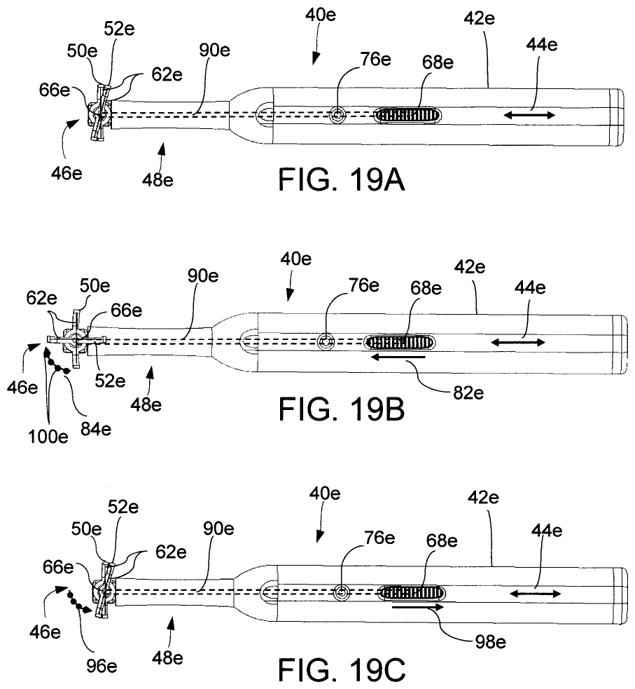

As best understood by comparing FIGS. 16 and 17 with the top views of the flossing tool 40d in FIGS. 18A-C, the angle adjustment mechanism 67d of the tool 40d in FIGS. 16-18C is not biased to any particular string position nor particular angle between the floss strings 62d. However, the adjustment mechanism 67d of the tool 40d does restrict rotation of the rotatable string positioner 52d around the positioner pivot 66d unless the user activates the positioner motor 88d with the angle adjuster 68d. Being coupled to the positioner pivot 66d, the shaft gear 92d remains in direct geared engagement with the shaft gear 92d at the end of the shaft 90d. Therefore, any rotation of the rotatable string positioner 52d on the positioner pivot 66d requires corresponding rotation of the shaft 90d.

Consider a user flossing with the tool 40d. During use, assuming the floss strings 62d of the flossing tool 40d are initially positioned at a minimum angle as depicted in FIG. 18A, the user holds the tool 40d with one hand and exerts sliding pressure against the angle adjuster 68d to slide the angle adjuster 68d in the forward direction 82d as depicted in FIG. 18B. This switching forward movement of the angle adjuster 68d activates the positioner motor 88d which rotates the shaft 90d and shaft gear 92d and in turn rotating the positioner gear 94d and rotatable string positioner 52d to increase the angle between the floss strings 62d until a desired angle is achieved, for example, a maximum angle of 90 degrees as depicted in FIG. 18B. Although shown for illustrative purposes in this example as being rotatable to the maximum angle of 90 degrees, it will be appreciated that some contemplated embodiments of the invention may allow for rotation across a full arc of up to or nearly to 180 or 360 degrees within the intended scope of the invention.

As shown in FIG. 18C, to reduce the angle between the floss strings 62d, the user exerts sliding pressure to move angle adjuster 68d in the reverse direction 98d. The switching reverse movement of the angle adjuster 68 activates the positioner motor 88d and/or any reverse gearing to reverse rotate the shaft 90d and shaft gear 92d and in turn reverse rotate the positioner gear 94d and rotatable string positioner 52d to reduce the angle between the floss strings 62d until a desired reduced angle is achieved, for example, a minimum angle of approximately 15 degrees as depicted in FIG. 18C.

Although shown and described as having a continuous motion angle adjustment mechanism 67d in FIGS. 16-18C, it will be appreciated that the invention also contemplates motorized angle adjustment mechanisms having discreet selectable angles between floss strings. For example, FIGS. 19A-C depict top views of an actuated flossing tool 40e of the invention highly similar to the tool 40d of FIGS. 16-18C. However the tool 40e includes an angle adjustment mechanism 67e in which activation of the positioner motor 88e will allow selectable rotation of the rotatable string positioner 52e only to multiple discreet angle positions 100e along the arc of rotation in the clockwise direction 84e, such as when the user increases the angle between floss strings 62e from a minimum angle (FIG. 19A) to a greater angle, such as the maximum of 90 degrees (FIG. 19B). For example, available angles between the strings 62e for a four-position system could be limited to 15 (min), 40, 65, and 90 (max) degrees along the arc of rotation. Reversing the angle adjustment mechanism 67e by sliding the angle adjuster 68e in the reverse direction 98e is similarly limited to the same discreet angles 100e along the arc of rotation in the counterclockwise direction 96e, such as when the user reduces the angle between floss strings 62e to a minimum angle (FIG. 19C).

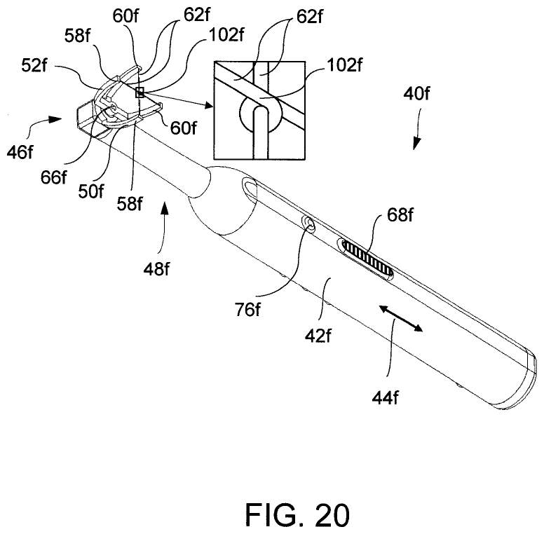

In some contemplated embodiments, floss strings from different string positioners can be interconnected to enhance interactive and combined cleaning between and around teeth during flossing. For example, FIG. 20 depicts an actuated flossing tool 40f according to one embodiment of the invention having one floss string 62f wrapped over the other at an overwrap point 102f in which the strings 62f cross while positioned on the tool 40f. This loose interconnection at the overwrap point 102f allows the strings 62f to better cooperate during flossing while still allowing for rotation of the rotatable string positioner 52f to adjust the angle between the strings 62f.

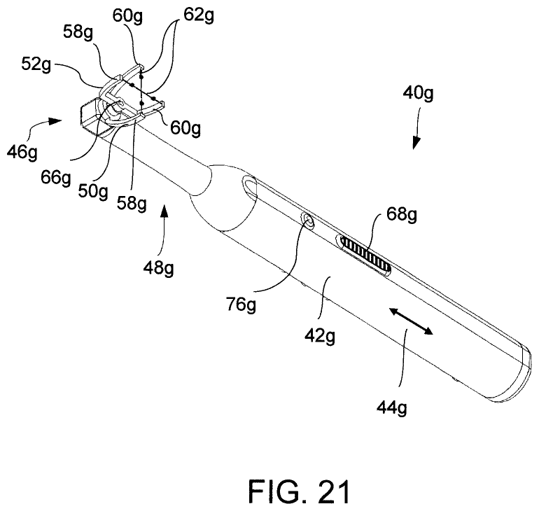

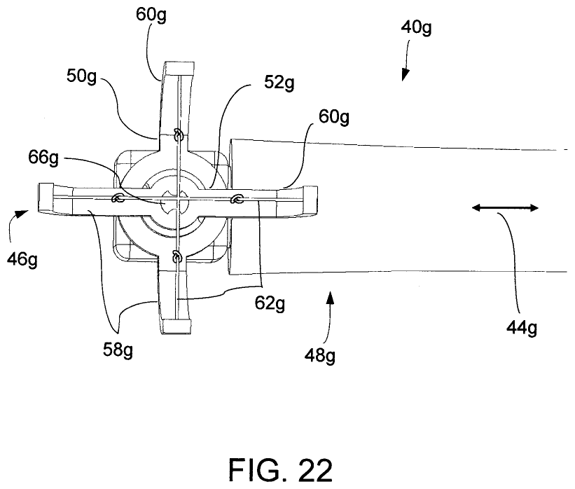

Some contemplated embodiments also allow for enhanced cleaning by each floss string individually. For example, FIG. 21 is a perspective view of an actuated flossing tool 40g of the invention in which two knots 104g are added to each floss string 62g to improve the individual cleaning action of each string 62g while flossing. The relative positioning of the knots 104g is best understood by comparing FIG. 21 with the magnified top view of the headstock 48g in FIG. 22. The addition of the knots 104g to the strings 62g is particularly advantageous and effective for the flossing action when combined with the vibrational enhancement of the vibrator (not shown in FIG. 21) positioned within the handle or tool body 42g.

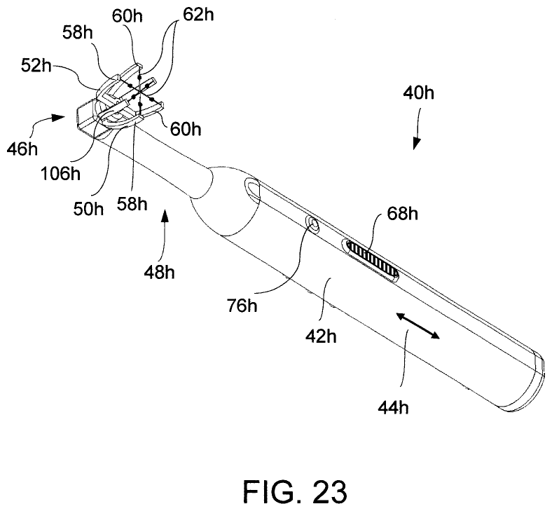

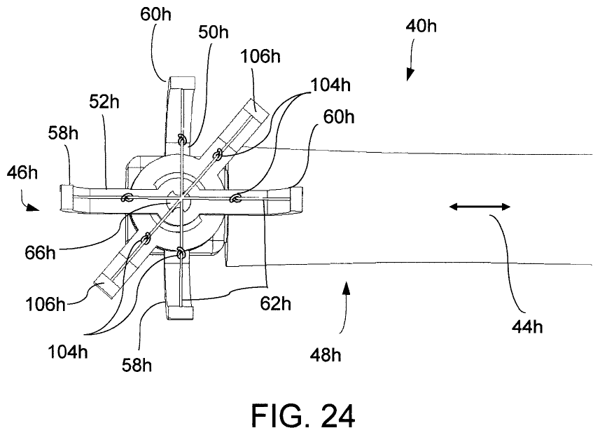

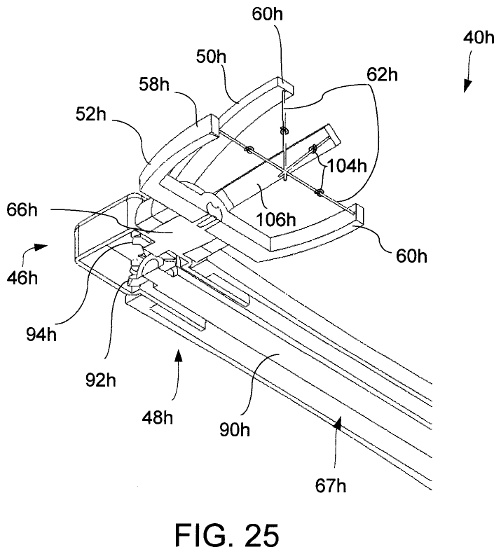

Although the invention has been shown and described with example embodiments having two string positioners for securing and positioning individual strings, it will be appreciated that embodiments having more than two string positioners and more than two floss strings are within the contemplated scope of the invention. For example, FIG. 23 depicts an actuated flossing tool 40h of the invention having a third string positioner 106h securing and positioning a third floss string 62h. The relative placement of the third string positioner 106h and third floss string 62h is best understood by comparing FIG. 23 with the magnified top view of the headstock 48h in FIG. 24 and the perspective, magnified cross sectional view of the headstock 48h in FIG. 25. The third string positioner 106h is located between the initial string positioner 50h and rotatable string positioner 52h. However, like the initial string positioner 50h but unlike the rotatable string positioner 52h, the third string positioner 106h is in fixed position relative to the tool 40d and headstock 48h and does not rotate around the positioner pivot 66h. As best understood with reference to FIG. 25, the shaft 90h, shaft gear 92h, and positioner gear 94h of the angle adjustment mechanism 67h are nevertheless able to fit and rotate within the headstock 48h to rotate the rotatable string positioner 52h to adjust the angles between the string of the rotatable string positioner 52h and initial and third string positioners 50h and 106h.

Although the invention has been shown and described as having only a single string positioner that rotates to change the angle of a single string with respect to one or more other string positioners, it will be appreciated that the use of multiple rotating string positioners and multiple moving strings is contemplated to be within the scope of the current invention, as is the use of any number of string positioners in total.

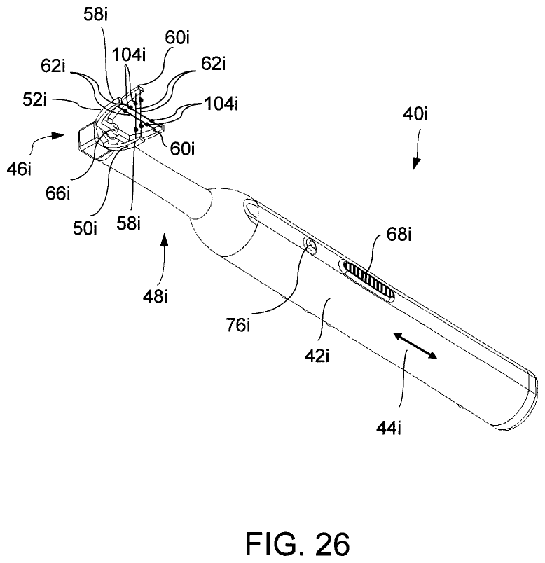

The use of multiple floss strings on a single string positioner is also within the contemplated invention scope. For example, FIG. 26 depicts an actuated flossing tool 40i of the invention having multiple floss strings 62i on each of the initial and rotatable string positioners 50i and 52i. As depicted in FIG. 26, a pair of floss strings 62i extends between the first positioner arm 58i and second positioner arm 60i of each string positioner, with one string 62i extending directly above the other while both strings 62i also cross a string 62i of the other positioner. Combined with the pair of knots 104i on each string, this arrangement is particularly effective for flossing when combined with the vibrations from the vibrator (not shown in FIG. 26) contained within the handle or tool body 42i.

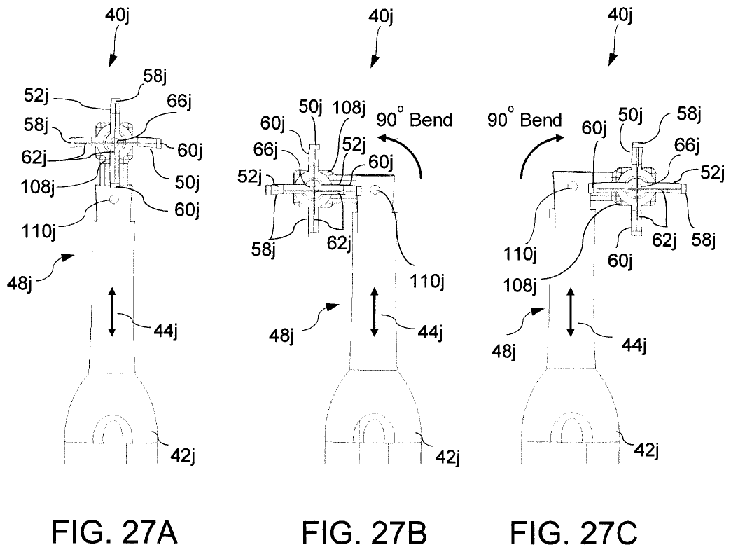

In some contemplated embodiments, a flossing tool can be adjusted into various orientations to allow for unusual or complicated positioning where access to certain floss areas may require access from angles with limited access. For example, FIG. 27A depicts an actuated flossing tool 40j of the invention having an outer headstock portion 108j at the first distal end 46j of the tool 40j. Comparing FIG. 27A with FIG. 27B and FIG. 27C, the outer headstock portion 108j is pivotally mounted to rotate with respect to the rest of the headstock 48j, tool body 42j, and major tool axis 44j. Such rotation allows for a 90 degree bend from center (FIG. 27A) to the left (FIG. 27B) or to the right (FIG. 27C). It will be appreciated that other tool orientation adjustments can be implemented into various embodiments within the intended scope of the invention.

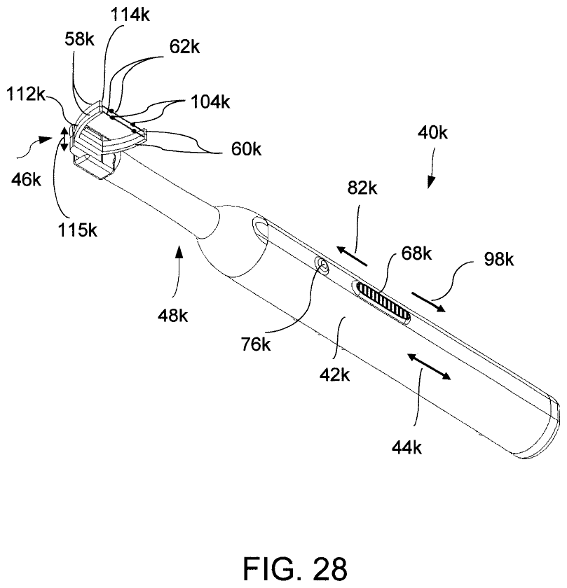

The invention further contemplates some embodiments in which multiple floss strings do not cross, but rather stay in parallel to each other. For example, FIG. 28 depicts an actuated flossing tool 40k of the invention having a major tool axis 44k, a first distal end 46k, and a headstock 48k at the first distal end 46k. A first string positioner 112k and a second string positioner 114k, each having a first positioner arm 58k and a second positioner arm 60k and a floss string 62m extending between the first and second positioner arms 58k and 60k. The first and second string positioners 112k and 114k are positioned side by side with the floss strings 62m of both string positioners being parallel to each other.

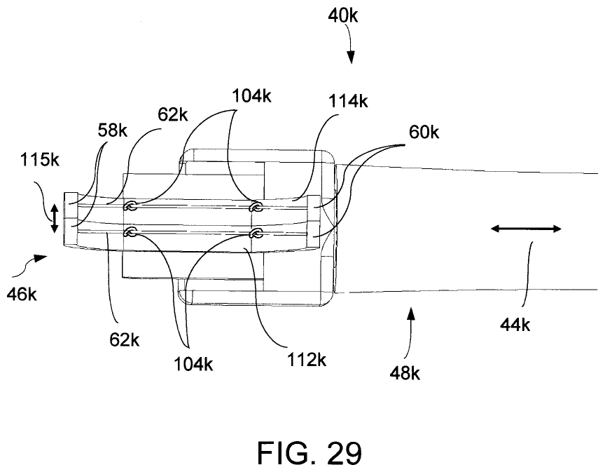

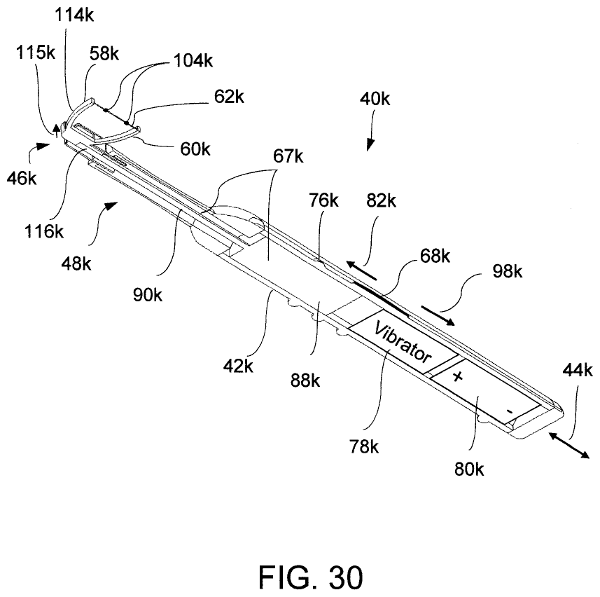

As best understood by comparing FIG. 28 with the magnified top view of the headstock 48k in FIG. 29, the first and second string positioners 112k and 114k can reciprocate outwardly in the outward directions 115k while the floss strings 62m remain parallel to each other. However, as depicted in FIGS. 28 and 29, the string positioners 112k and 114k are spring biased to an adjacent string position in which the spacing between the floss strings 62k is minimized. Referring now to the cross sectional perspective view of the tool 40k in FIG. 30, the tool 40k includes a vibrator 78k and battery 80k and an angle adjustment mechanism 67k, the angle adjustment mechanism 67k comprising an angle adjuster 68k, positioner motor 88k, and shaft 90k. The positioner motor 88k actuates the shaft 90k to reciprocate in directions along the major tool axis 44k.

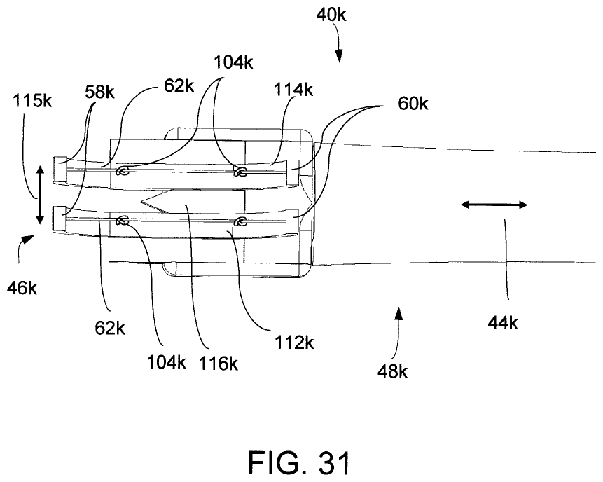

As best understood by comparing FIGS. 28-31, while flossing, a user can activate the positioner motor 88k by sliding the angle adjuster 68k in the forward direction 82k. The positioner motor 88k in turn pushes the shaft 90k in the forward direction towards the first distal end 46k of the tool 40k. Now comparing FIG. 29 with FIG. 31, the shaft 90k ends with wedge 116k which separates the first and second string positioners 112k and 114k as the shaft 90k moves towards the first distal end 46k, moving the first and second string positioners 112k and 114k away from their biased adjacent string positions depicted in FIG. 29 to second string positions, further separating the floss strings 62k as shown in FIG. 31. The user can then return the string positioners to their adjacent string positions by moving the angle adjuster 68k in the reverse direction 98k, which activates the positioner motor 88k to reverse the shaft 98k, thereby withdrawing the wedge 116k from between the first and second string positioners 112k and 114k, which then return under their spring biases to their adjacent string positions as depicted in FIG. 29.

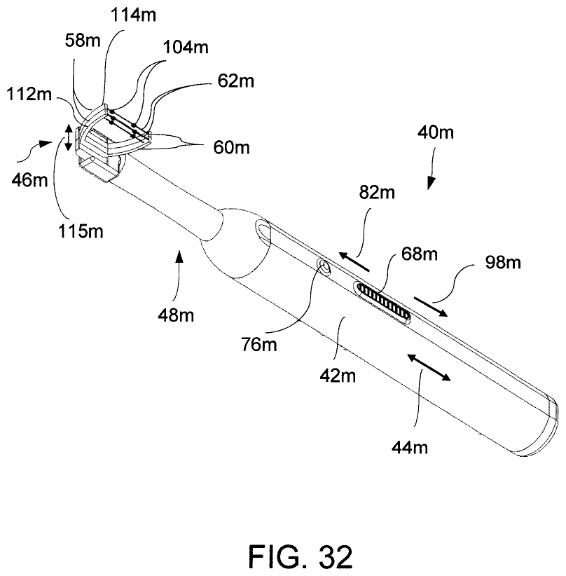

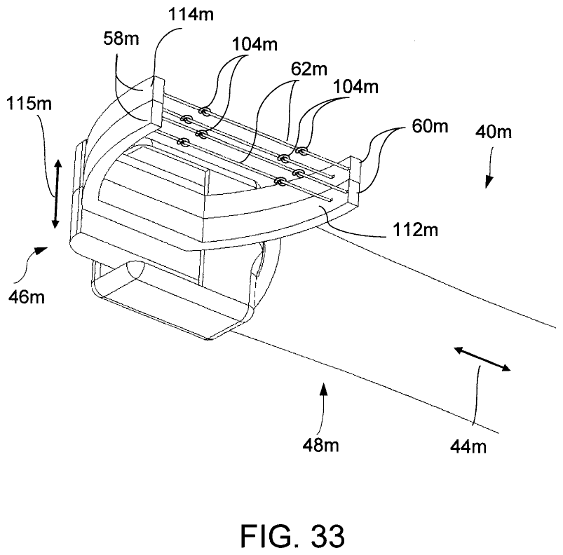

To improve the effectiveness of flossing, embodiments of the invention having parallel floss strings can also incorporate knots in the floss strings, as in the embodiment depicted in FIGS. 28-31, or incorporate more than one floss string on each individual floss positioner. FIGS. 32 and 33 depict an actuated flossing tool 40m of the invention very similar to the flossing tool 48k of FIGS. 28-31 but having multiple floss strings 62m on both the first and second string positioners 112m and 114m. As best understood by comparing the perspective view of the tool 40m in FIG. 32 with the magnified perspective view of the headstock 48m in FIG. 33, all of the floss strings 62m are in positioned in parallel to each other and remain in parallel positions when moved back and forth between their adjacent and second string positions.

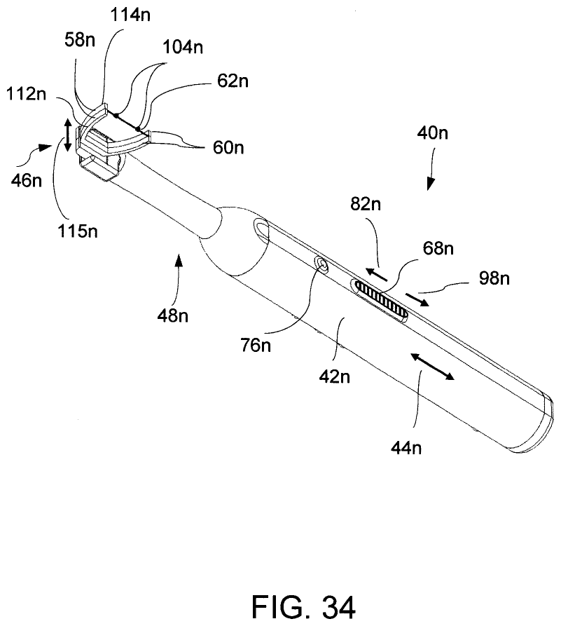

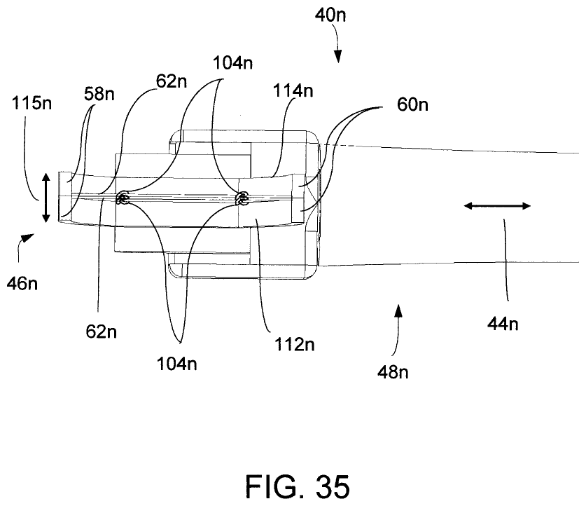

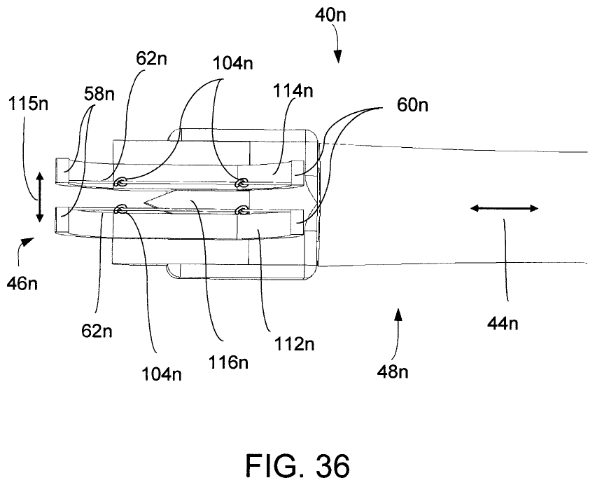

Although embodiments of the invention having parallel floss strings have been shown and described as having floss strings that do not touch even when the floss positioners touching at minimum positions, it will be appreciated that floss strings can also touch and therefore eliminate any space therebetween at adjacent string positions. FIG. 34 depicts an actuated flossing tool 40n of the invention very similar to the flossing tool 48k of FIGS. 28-31 but having floss strings 62n on the first and second string positioners 112n and 114n that are in touching contact with each other while the first and second string positioners 112n and 114n are in their adjacent string positions, as best understood by comparing FIG. 34 with the magnified top view of the headstock 48n in FIG. 35. The floss strings 62n of the first and second string positioners 112n and 114n remain in the touching contact depicted in FIGS. 34 and 35 until the user slides the angle adjuster 68n in the forward direction 82n to move the first and second string positioners 112n and 114n to their second string positions.

Those skilled in the art will realize that this invention is capable of embodiments different from those shown and described. It will be appreciated that the detail of the structure of the disclosed apparatuses and methodologies can be changed in various ways without departing from the invention itself. Accordingly, the drawings and Detailed Description of the Invention are to be regarded as including such equivalents as do not depart from the spirit and scope of the invention.

1. An actuated flossing tool comprising:
a tool body having a major tool axis, a first distal end, and a headstock, said headstock positioned at or near said first distal end;
an initial string positioner and a rotatable string positioner, each of said initial string positioner and said rotatable string positioner having a first positioner arm and a second positioner arm, at least one of said initial string positioner and said rotatable string positioner being positioned on said headstock;
each of said initial string positioner and said rotatable string positioner having at least one floss string extending from said first positioner arm to said second positioner arm, at least one said floss string of said initial string positioner crossing at least one said floss string of said fixed string positioner relative to said headstock;
said rotatable string positioner being positioned to rotate on a positioner pivot from a first string position to at least a second string position relative said headstock, said floss string of said rotatable string positioner crossing said floss string of said initial string positioner at least when said rotatable string positioner rotates from said first string position to said second string position;
an angle adjuster, said angle adjuster positioned to allow adjustment of said rotatable string positioner from at least said first string position to at least said second string position; and
a vibrator, said vibrator positioned to vibrate said floss strings during use.

2. The actuated flossing tool of claim 1 further comprising at least two floss strings extending between said first positioner arm and said second positioner arm of at least one of said initial and fixed string positioners.

3. The actuated flossing tool of claim 1 further comprising at least a third string positioner having at least one floss string crossing the floss strings of each of said initial and fixed string positioners.

4. The actuated flossing tool of claim 1 further comprising said angle adjuster effects adjustment of said rotatable string positioner around said positioner pivot with an adjuster motor.

5. The actuated flossing tool of claim 1 further comprising said angle adjuster is slidable on said tool body and positioned to reciprocate along said major tool axis.

6. The actuated flossing tool of claim 1 further comprising said first position of said rotatable string positioner creating an angle of about 15 degrees between said floss string of said rotatable string positioner and said floss string of said fixed string positioner.

7. The actuated flossing tool of claim 1 further comprising said second position of said rotatable string positioner creating an angle of about 90 degrees between said floss string of said rotatable string positioner and said floss string of said fixed string positioner.

8. The actuated flossing tool of claim 1 further comprising said second position of said rotatable string positioner creating any angle from about zero to 90 degrees between said floss string of said rotatable string positioner and said floss string of said fixed string positioner.

9. The actuated flossing tool of claim 1 further comprising said second position of said rotatable string positioner creating any one of a plurality of preselected angles from about zero to 90 degrees between said floss string of said rotatable string positioner and said floss string of said fixed string positioner.

10. The actuated flossing tool of claim 1 further comprising a power switch located on said tool body to operate said vibrator.

11. The actuated flossing tool of claim 1 further comprising a battery to provide electrical power to said vibrator.

12. The actuated flossing tool of claim 1 further comprising a power switch located on said tool body to operate said vibrator, said power switch being a clickable button.

13. The actuated flossing tool of claim 1 further comprising a power switch located on said tool body to operate said vibrator, said power switch being a rotatable dial allowing a user to adjust the speed of said vibrator.

14. The actuated flossing tool of claim 1 further comprising a power switch located on said tool body to operate said vibrator, said power switch being a rotatable dial allowing a user to adjust the speed of said vibrator to one of a plurality of preselected speeds.

15. The actuated flossing tool of claim 1 further comprising a headstock pivot allowing for the positioning of said headstock at an angle away from said major tool axis.

16. The actuated flossing tool of claim 1 wherein said vibrator comprises a rotational motor and cam.

17. The actuated flossing tool of claim 1 wherein said vibrator comprises an oscillator.

18. An actuated flossing tool comprising:
a tool body having a major tool axis, a first distal end, and a headstock, said headstock positioned at or near said first distal end;
an initial string positioner and a rotatable string positioner, each of said initial string positioner and said rotatable string positioner having a first positioner arm and a second positioner arm, each of said initial string positioner and said rotatable string positioner being positioned on said headstock;
each of said initial string positioner and said rotatable string positioner having at least one floss string extending from said first positioner arm to said second positioner arm, at least one said floss string of said initial string positioner crossing at least one said floss string of said fixed string positioner relative to said headstock;
said rotatable string positioner being positioned to rotate on a positioner pivot from a first string position to at least a second string position relative said headstock, said floss string of said rotatable string positioner crossing said floss string of said initial string positioner as said rotatable string positioner rotates from said first string position to said second string position;
an angle adjuster, said angle adjuster positioned to reciprocate on said tool body along said major tool axis, said angle adjuster being further positioned to rotate said rotatable string positioner on said positioner pivot from at least said first string position to at least said second string position;
a vibrator, said vibrator positioned to vibrate said floss strings; and
a power switch, said power switch being positioned on said tool body; said power switch being further positioned to allow a user to operate said vibrator to vibrate said floss strings during use.

19. The actuated flossing tool of claim 18 further comprising at least two floss strings extending between said first positioner arm and said second positioner arm of at least one of said initial and fixed string positioners.

20. The actuated flossing tool of claim 18 further comprising at least a third string positioner having at least one floss string crossing the floss strings of each of said initial and fixed string positioners.

21. The actuated flossing tool of claim 18 further comprising said angle adjuster effects adjustment of said rotatable string positioner around said positioner pivot with an adjuster motor.

22. The actuated flossing tool of claim 18 further comprising said angle adjuster is slidable on said tool body and positioned to reciprocate along said major tool axis.

23. The actuated flossing tool of claim 18 further comprising said first position of said rotatable string positioner creating an angle of about 15 degrees between said floss string of said rotatable string positioner and said floss string of said fixed string positioner.

24. The actuated flossing tool of claim 18 further comprising said second position of said rotatable string positioner creating an angle of about 90 degrees between said floss string of said rotatable string positioner and said floss string of said fixed string positioner.

25. The actuated flossing tool of claim 18 further comprising said second position of said rotatable string positioner creating any angle from about zero to 90 degrees between said floss string of said rotatable string positioner and said floss string of said fixed string positioner.

26. The actuated flossing tool of claim 18 further comprising said second position of said rotatable string positioner creating any one of a plurality of preselected angles from about zero to about 90 degrees between said floss string of said rotatable string positioner and said floss string of said fixed string positioner.

27. The actuated flossing tool of claim 18 further comprising a battery to provide electrical power to said vibrator.

28. The actuated flossing tool of claim 18 further comprising said power switch being a clickable button.

29. The actuated flossing tool of claim 18 further comprising said power switch being a rotatable dial allowing a user to adjust the speed of said vibrator.

30. The actuated flossing tool of claim 18 further comprising said power switch being a rotatable dial allowing a user to adjust the speed of said vibrator to one of a plurality of preselected speeds.

31. The actuated flossing tool of claim 18 further comprising a headstock pivot allowing for the positioning of said headstock at an angle away from said major tool axis.

32. The actuated flossing tool of claim 18 wherein said vibrator comprises a rotational motor and cam.

33. The actuated flossing tool of claim 18 wherein said vibrator comprises an oscillator.

34. An actuated flossing tool comprising:
a tool body having a major tool axis, a first distal end, and a headstock, said headstock positioned at or near said first distal end;
an initial string positioner and a rotatable string positioner, each of said initial string positioner and said rotatable string positioner having a first positioner arm and a second positioner arm, each of said initial string positioner and said rotatable string positioner being positioned on said headstock;
each of said initial string positioner and said rotatable string positioner having at least one floss string extending from said first positioner arm to said second positioner arm, at least one said floss string of said initial string positioner crossing at least one said floss string of said fixed string positioner relative to said headstock;
said rotatable string positioner being positioned to rotate on a positioner pivot from a first string position to at least a second string position relative said headstock, said floss string of said rotatable string positioner crossing said floss string of said initial string positioner as said rotatable string positioner rotates from said first string position to said second string position;
an angle adjuster, said angle adjuster positioned to reciprocate on said tool body along said major tool axis;
an adjuster shaft, said angle adjuster being positioned to move said adjuster shaft to rotate said rotatable string positioner on said positioner pivot from at least said first string position to at least said second string position;
a vibrator, said vibrator positioned to vibrate said floss strings; and
a power switch, said power switch being positioned on said tool body; said power switch being further positioned to allow a user to operate said vibrator to vibrate said floss strings during use.

35. The actuated flossing tool of claim 34 further comprising at least two floss strings extending between said first positioner arm and said second positioner arm of at least one of said initial and fixed string positioners.

36. The actuated flossing tool of claim 34 further comprising at least a third string positioner having at least one floss string crossing the floss strings of each of said initial and fixed string positioners.

37. The actuated flossing tool of claim 34 further comprising said first position of said rotatable string positioner creating an angle of about 15 degrees between said floss string of said rotatable string positioner and said floss string of said fixed string positioner.

38. The actuated flossing tool of claim 34 further comprising said second position of said rotatable string positioner creating an angle of about 90 degrees between said floss string of said rotatable string positioner and said floss string of said fixed string positioner.

39. The actuated flossing tool of claim 34 further comprising said second position of said rotatable string positioner creating any angle from about zero to 90 degrees between said floss string of said rotatable string positioner and said floss string of said fixed string positioner.

40. The actuated flossing tool of claim 34 further comprising said second position of said rotatable string positioner creating any one of a plurality of preselected angles from about zero to 90 degrees between said floss string of said rotatable string positioner and said floss string of said fixed string positioner.

41. The actuated flossing tool of claim 34 further comprising a battery to provide electrical power to said vibrator.

42. The actuated flossing tool of claim 34 further comprising said power switch being a clickable button.

43. The actuated flossing tool of claim 34 further comprising said power switch being a rotatable dial allowing a user to adjust the speed of said vibrator.

44. The actuated flossing tool of claim 34 further comprising said power switch being a rotatable dial allowing a user to adjust the speed of said vibrator to one of a plurality of preselected speeds.

45. The actuated flossing tool of claim 34 further comprising a headstock pivot allowing for the positioning of said headstock at an angle away from said major tool axis.

46. The actuated flossing tool of claim 34 wherein said vibrator comprises a rotational motor and cam.

47. The actuated flossing tool of claim 34 wherein said vibrator comprises an oscillator.

48. An actuated flossing tool comprising:
a tool body having a major tool axis, a first distal end, and a headstock, said headstock positioned at or near said first distal end;
an initial string positioner and a rotatable string positioner, each of said initial string positioner and said rotatable string positioner having a first positioner arm and a second positioner arm, each of said initial string positioner and said rotatable string positioner being positioned on said headstock;
each of said initial string positioner and said rotatable string positioner having at least one floss string extending from said first positioner arm to said second positioner arm, at least one said floss string of said initial string positioner crossing at least one said floss string of said fixed string positioner relative to said headstock;
said rotatable string positioner being positioned to rotate on a positioner pivot from a first string position to at least a second string position relative said headstock, said floss string of said rotatable string positioner crossing said floss string of said initial string positioner as said rotatable string positioner rotates from said first string position to said second string position;
an angle adjuster, said angle adjuster positioned to reciprocate on said tool body along said major tool axis, said angle adjuster being further positioned to rotate said rotatable string positioner on said positioner pivot from said first string position to at least said second string position;
a vibrator, said vibrator positioned to vibrate said floss strings; and
a variable power switch, said variable power switch being positioned on said tool body; said power switch being further positioned to allow a user to operate said vibrator to vibrate said floss strings at selectable vibration speeds during use.

49. The actuated flossing tool of claim 48 further comprising at least two floss strings extending between said first positioner arm and said second positioner arm of at least one of said initial and fixed string positioners.

50. The actuated flossing tool of claim 48 further comprising at least a third string positioner having at least one floss string crossing the floss strings of each of said initial and fixed string positioners.

51. The actuated flossing tool of claim 48 further comprising said angle adjuster effects adjustment of said rotatable string positioner around said positioner pivot with an adjuster motor.

52. The actuated flossing tool of claim 48 further comprising said angle adjuster is slidable on said tool body and positioned to reciprocate along said major tool axis.

53. The actuated flossing tool of claim 48 further comprising said first position of said rotatable string positioner creating an angle of about 15 degrees between said floss string of said rotatable string positioner and said floss string of said fixed string positioner.

54. The actuated flossing tool of claim 48 further comprising said second position of said rotatable string positioner creating an angle of about 90 degrees between said floss string of said rotatable string positioner and said floss string of said fixed string positioner.

55. The actuated flossing tool of claim 48 further comprising said second position of said rotatable string positioner creating any angle from about zero to 90 degrees between said floss string of said rotatable string positioner and said floss string of said fixed string positioner.

56. The actuated flossing tool of claim 48 further comprising said second position of said rotatable string positioner creating any one of a plurality of preselected angles from about zero to about 90 degrees between said floss string of said rotatable string positioner and said floss string of said fixed string positioner.

57. The actuated flossing tool of claim 48 further comprising a battery to provide electrical power to said vibrator.

58. The actuated flossing tool of claim 48 further comprising said variable power switch being a clickable button.

59. The actuated flossing tool of claim 48 further comprising said variable power switch being a rotatable dial allowing a user to adjust the speed of said vibrator.

60. The actuated flossing tool of claim 48 further comprising said variable power switch being a rotatable dial allowing a user to adjust the speed of said vibrator to one of a plurality of preselected speeds.

61. The actuated flossing tool of claim 48 further comprising a headstock pivot allowing for the positioning of said headstock at an angle away from said major tool axis.

62. The actuated flossing tool of claim 48 wherein said vibrator comprises a rotational motor and cam.

63. The actuated flossing tool of claim 48 wherein said vibrator comprises an oscillator.

64. An actuated flossing tool comprising:
a tool body having a major tool axis, a first distal end, and a headstock, said headstock positioned at or near said first distal end;
a first string positioner and a second string positioner, each of said first string positioner and said second string positioner having a first positioner arm and a second positioner arm, at least one of said first and second string positioners being positioned on said headstock;
each of said first string positioner and said second string positioner having at least one floss string extending from said first positioner arm to said second positioner arm, said floss string of said first string positioner being parallel to said floss string of said second string positioner;
each of said first string positioner and said second string positioner being biased to an adjacent string position, at least one of said first string positioner and said second string positioner being movable to a second string position;
the distance between said first string positioner and said second string positioner being greater when at least one of said first and second string positioners are in said second string position than when said first and second string positioners are in said adjacent positions;
a distance adjuster, said distance adjuster being positioned to allow adjustment of at least one of said first and second string positioners from said adjacent position to said second string position; and
a vibrator, said vibrator positioned to vibrate said floss strings during use.

65. The actuated flossing tool of claim 64 wherein said vibrator comprises a rotational motor and cam.

66. The actuated flossing tool of claim 64 wherein said vibrator comprises an oscillator.

67. The actuated flossing tool of claim 64 further comprising said floss strings being in touching contact when both said first string positioner and said second string positioner are in said adjacent positions.

68. The actuated flossing tool of claim 64 further comprising said floss strings not being in touching contact when both said first string positioner and said second string positioner are in said adjacent positions.

69. The actuated flossing tool of claim 64 further comprising said floss strings not being in touching contact when at least one of said first string positioner and said second string positioner are in said second string positions.

70. The actuated flossing tool of claim 64 further comprising an adjustment mechanism to move said first string positioner and said second string positioner from said adjacent string positions to said second string positions.

71. The actuated flossing tool of claim 64 further comprising a wedge to move said first string positioner and said second string positioner from said adjacent string positions to said second string positions.
